(19) United States
(12) Patent Application Publication
(10) Pub. No.: US 2009/0229531 A1
(43) Pub. Date: Sep. 17, 2009

(54) CORROSION-COMPENSATED NET

(76) Inventor: Harold M. STILLMAN, Greenwich, CT (US)

Correspondence Address: WINSTON & STRAWN LLP;PATENT DEPARTMENT, 1700 K STREET, N.W., WASHINGTON, DC, 20006, US

(21) Appl. No.: 12/049,010

(22) Filed: Mar. 14, 2008

(51) Int. Cl. A01K 61/00

(52) U.S. Cl. 119/215

(57) ABSTRACT

The present invention is directed to a corrosion-compensated net. A preferred embodiment has upper and lower net regions associated with each other to provide a wall. Each of the upper and lower net regions has an outer portion of a corrodible material. The respective outer portions of the upper and lower net regions are differently configured to compensate for a difference between corrosiveness levels of the environments at the upper and lower portions. The upper net portion can be configured to withstand a higher corrosiveness level than that of the lower net portion when exposed to the environment for equal amounts of time. In such an embodiment, the respective outer portions of the upper and lower net regions can have different thicknesses to compensate for the difference between corrosiveness levels of the environments at the upper and lower portions.

### FIELD OF INVENTION

The present invention relates to an aquaculture enclosure typically used to cultivate fish. More specifically, the present invention relates to an aquaculture net constructed of a plurality of net sections having differing thicknesses.

### BACKGROUND OF THE INVENTION

The marine industry seeks to provide a multitude of fish products by growing fish in a controlled environment. The industry is currently experiencing rapid growth, resulting in a many different types of equipment that are necessary to nurture and harvest fish. When compared to the conventional techniques that are employed by most commercial fishing operations to harvest wild fish, the advantages of marine aquaculture are several, among them are predictable yields in terms of the number of fish harvested, as well as reductions in labor and equipment costs. This is a welcome development both from the standpoint of profitability and meeting the global demand for seafood.

The typical marine aquaculture enclosure has a weighted, polymer fiber mesh net formed into a rectangular, square or round cage that is suspended in a water body by attached floatation devices. The cage contains the fish for a period of months. For example, farm-raised salmon spend about 18 months enclosed in cages. In addition to containing the fish for easy feeding and harvesting, the cage provides protection from aquatic predators such as seals and sea lions. At the end of a given growth period, the fish crop is removed from the cage.

Metallic cages, typically constructed of galvanized steel or special anti-fouling copper alloy wires, are also used in marine aquaculture. The service lifetime of metallic wire nets is limited primarily by mechanical wear, surface corrosion, and fretting corrosion. Wear, leading to holes in the net, is caused by the relative motion of opposing surfaces due to movement of the net as a consequence of wave and water currents or by the repetitive movement of fish against the net. Corrosion of metallic nets reduces the thickness of the net and can lead to failure of the net and escape of the fish. Corrosion significantly shortens the service life of the cage.

The corrosive action of sea water consumes and reduces the thickness of the metal nets, thereby limiting the useful life of the cage. It is not practical, however, to increase the thickness of the metal used in the net to increase service life because this would significantly increase the weight of the net and the size and cost of the floatation system. A typical cage for large scale fish culture can have dimensions of 30 meters length by 30 meters width by 15 meters depth and contain up to 20 tons of metal. This increase in weight places heavy demands on the net floatation and mooring systems. Further, decreasing the opening size of the netting requires more cage material, thus increasing the surface area upon which pathogens can grow and decreasing the amount of oxygen that can reach the fish inside the cage.

To address the concerns of corrosion, cages have been developed from synthetic materials such as nylon, plastic, and other polymers. Synthetic cages produce a host of other issues, however. The synthetic materials are particularly susceptible to biofouling, which refers to an accumulation on the net of parasites and other pathogens that are harmful to the fish being cultivated. The growth of parasites results in diseased fish, requiring the use or increased use of antibiotics in an attempt to keep the fish healthy. In addition, fouling decreases the flow of clean oxygenated water into the cage which can adversely affect fish health.

U.S. Pat. No. 6,386,146 discloses an aquaculture cage having a side wall and a bottom wall made of linked, corrosion-resistant, spiral mesh to form an enclosure. The cage is maintained at the surface of the water by a buoyant upper support. Japanese Patent No. 2001-190179 discloses a fish preserve with a net made of metallic copper or copper alloy wires that are coated with a corrosion-resistant film. U.S. Pat. No. 5,987,086 discloses an aquaculture system made of metallic, corrosion resistant wire having a diameter greater than 20 gauge. Thus, there is a need in the art for a cage that withstands corrosion while reducing excess material usage. The present invention provides an improved aquaculture system that addresses these challenges.

### SUMMARY OF THE INVENTION

The present invention is directed to a corrosion-compensated net. A preferred embodiment has upper and lower net regions associated with each other to provide a wall. Each of the upper and lower net regions has an outer portion of a corrodible material. The respective outer portions of the upper and lower net regions are differently configured to compensate for a difference between corrosiveness levels of the environments at the upper and lower portions. The upper net portion can be configured to withstand a higher corrosiveness level than that of the lower net portion when exposed to the environment for equal amounts of time. In such an embodiment, the respective outer portions of the upper and lower net regions can have different thicknesses to compensate for the difference between corrosiveness levels of the environments at the upper and lower portions.

In an embodiment, the upper net region further includes an inner portion formed within the outer portion of the upper net region. Further, the lower net region can include a core formed within the outer portion of the lower net region. In the preferred embodiment, the outer portion of comprises the entire cross-section of one or both net portions, each net portion being made of a single material, which may be an alloy.

The upper and lower net regions preferably each have wire meshes, and the upper portion can have a greater wire diameter or minor diameter, or a lower gage than the wires of the lower net region. In embodiments with different inner and outer portions the outer portion can have a greater thickness in the upper net region than the lower net region.

In an additional embodiment, the net further includes a mid net region associated with the upper and lower net regions. The mid net region can have a material thickness that is different than the material thicknesses of the upper and lower portions. The mid net region can also be disposed between the upper and lower net regions, having a material thickness that is between the material thicknesses of the upper and lower portions. In other embodiments, the mid net region include a plurality of subsection or sub-portions having different material thicknesses. The plurality of subsections can have thicknesses decreasing from the upper net region to the lower net region, such that the cage has a graded thickness decreasing with increasing depth, or can have another pattern of thickness gradation or distribution.

The corrosion-compensated net can include a connector element that associates the upper and lower net regions. The connector element can directly connect the upper and lower portions, or can connect them indirectly via other net regions that are disposed therebetween.

The upper and lower net regions are preferably made of a material that is corrodible by salt water. More preferably, the upper and lower net regions are made of a metal. The metal can include a copper alloy, which can include at least one of nickel, tin, and zinc.

In one embodiment of the invention, the corrosion-compensated net includes a support member, such as a flotation device, associated with the upper portion. The support member is preferably configured for supporting the upper portion at or near a surface of a body of water, and the upper portion can extend to above the surface.

A preferred embodiment of a closed aquaculture cage configured to contain marine life for aquaculture includes the corrosion-compensated net. The cage can include a generally vertical wall that comprises the net, such that the net defines a horizontal perimeter of the cage. The net can also extend generally horizontally at the bottom of the generally vertical wall to define a bottom wall of the cage.

A further embodiment relates to an aquaculture cage including an enclosure adapted to contain marine life for aquaculture and including at least one wall segment having upper and lower portions. Each of the upper and lower wall segment portions has a different compensated degradation quality, which can be material thickness such as wire gauge or the like.

### BRIEF DESCRIPTION OF THE DRAWINGS

The invention will be better understood in relation to the attached, non-limiting drawings illustrating preferred embodiments, wherein:

FIG. 1 is a perspective view of a preferred embodiment of a graded net cage for marine aquaculture according to the present invention;

FIG. 2 is a front view of a portion of a graded net for use in the graded net cage of FIG. 1;

FIG. 3 is a front view of a portion of another embodiment of a graded net that can be used with the graded net cage of FIG. 1;

FIG. 4 is a cross-sectional view of a portion of a used in an alternative embodiment of a graded net cage;

FIG. 5 is a cross-sectional view of a portion of the graded net cage of FIG. 1;

FIG. 6 is a side view of a portion of the graded net cage of FIG. 1; and

FIG. 7 is a graph showing an example of the corrosion rate of a material used to form a graded net in relation to the depth of the material below the surface of a body of water.

### DETAILED DESCRIPTION OF THE PREFERRED EMBODIMENTS

In describing embodiments below, specific terminology is employed for the sake of clarity. The invention, however, is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention.

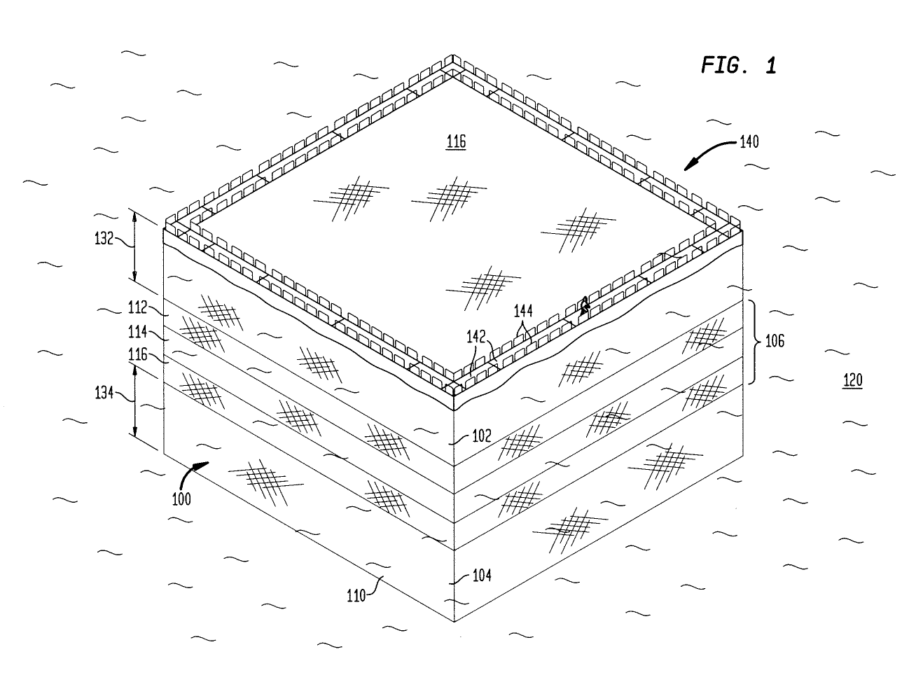

Referring to FIG. 1, cage 100 is submerged in a water body 120. Cage 100 includes a corrosion-compensated net, which can be configured to contain marine life for aquaculture such as fish. Cage 100 has a side wall 110, fashioned or bent in a manner that forms the walls of the net. In the embodiment of FIG. 1, there are four walls, although a different number of walls can alternatively be employed and the cage can alternatively have a different shape, such as a rounded cross-section. Side wall 110 of the cage 100 is formed of a metallic, corrosion-resistant material, and can be arranged in a wire mesh.

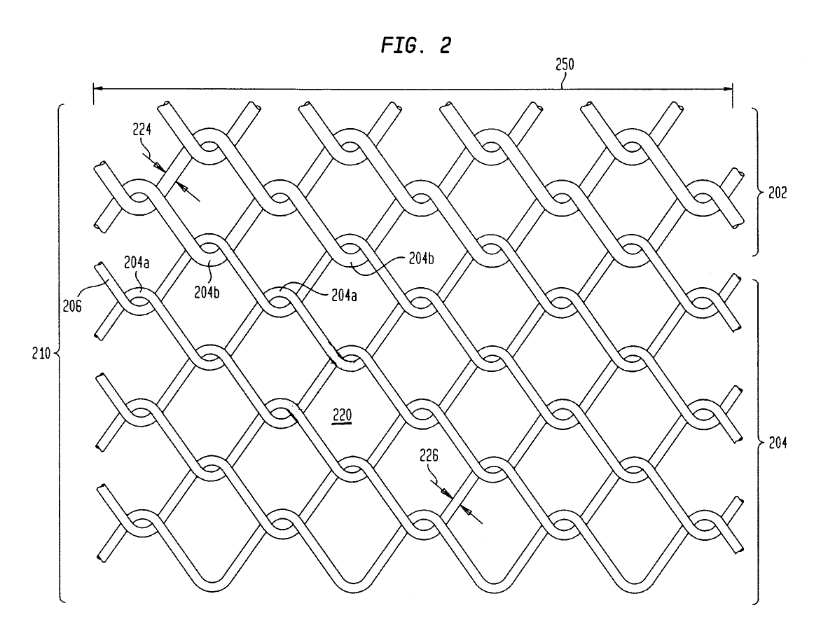

The corrosion-compensated net of the invention, as used in cage 100, includes an upper net region such as upper net portion 102, a lower net region such as lower net portion 104, and a mind net region such as mid net portion 106. Upper net portion 102 and lower net portion 104 have graded compensated degradation qualities such that the areas of the net in a more corrosive environment are more corrosion-resistant, while the areas of the net in less corrosive areas are less corrosion resistant. In a preferred embodiment, the wire mesh of the upper 102 and lower 104 net portions are of differing average, and more preferably minimum material thicknesses, as shown in FIG. 2. In certain embodiments, the material thickness can correspond to the diameter of the wire of the meshes. The wires can have a cross-section that is round, or a cross-section of other shape. In embodiments having a non-round cross-section, the material thickness preferably corresponds to the minor diameter or smallest thickness of the cross-section. Similarly, in embodiments that are made from structures other than wire, the material thickness preferably corresponds to the smallest thickness of the cross-section. Additionally or alternatively, the differing compensated degradation qualities of upper net portion 102 and lower net portion 104 can include the use of different materials such that, where necessary, the net is more corrosion resistant and, where corrosion resistance is less important, other characteristics, such as antifouling or weight, are optimized.

The difference in material thickness throughout the net is preferably selected to compensate for differences in corrosiveness of the environments surrounding each of these portions. Typically, corrosion rates are higher at the surface of the water, where the cage is exposed to more air and more turbulence. In a preferred embodiment, the average material thickness 224 of the upper net portion 202 is greater than the material thickness 226 of the lower net portion 204. The thickness of the mid net portion 106 (see FIG. 1) is between that of the upper and lower net portions 102, 104, although a different material thickness for the mid net portion can alternatively be used. The increased thickness 224 of the upper portion 202 helps the cage 100 withstand corrosion. In a preferred embodiment, the diameter of the wires of the mesh of the upper net portion 202 is greater than the diameter of the wire mesh of the lower net portion 204.

The wire mesh forming the upper net portion 108 can have a diameter of about 1-10 mm, preferably about 2-8 mm, more preferably about 3-6 mm, and in a particularly preferred embodiment, has a diameter of about 4 mm. The wire mesh can be woven to form a mesh opening 220 of about 5-50 mm, preferably about 10-40 mm, more preferably about 15-35 mm, and in a particularly preferred embodiment, the wire mesh is woven to form a 25 mm mesh opening. In other words, the openings of the mesh, which can be square in shape, measure 25 mm on a side. When discussing opening size, it is noted that conventional measurements of an opening in a chain-link net are taken along one side of the opening. Measurements of opening size in other types of nets, for example nylon woven nets, may be conventionally taken diagonally across the opening.

In preferred embodiments of the invention, openings 220 of the netting are optimized to minimize the amount of pathogen growth on the netting. For instance, if the opening size is reduced, more material is required, creating more surface area upon which pathogens can grow. This pathogen growth, in turn, decreases the amount of oxygen that is made available to the fish inside the cage. If the opening of the netting is too large, it cannot keep the fish inside cage and the predators outside the cage. Thus, embodiments of the invention utilize an opening size that considers and balances these factors.

The height of the upper net portion 102 can measure, about 0.5-15 meters preferably about 1-10 meters, more preferably about 2-6 meters, and in a particular preferred embodiment, the height is about 2 meters. This height is measured from point where the cage 100 meets the surface of the water 122, this height shown in FIG. 1 as reference numeral 132. The horizontal width of the cage walls can range from about 5-50 meters, preferably about 15-30 meters, more preferably about 10-20 meters, and in a particular preferred embodiment, the width of a cage wall is about 12 meters. The walls of the cages can have similar or differing widths. In accordance with one embodiment of the invention, the cage can have dimensions of 12 meters×12 meters×10 meters deep. The cage preferably consists of four sides, but can contain an increased or decreased number of sides. In one embodiment, the invention has four sides of 30 meters by 15 meters, and a bottom of 30 meters by 30 meters.

Preferably, the wire mesh as shown in FIG. 2 of the upper 202 and lower 204 net portions have differing respective gauges, such that a lower gauge is used for the wires of the upper net portion 202 than for the wire of the lower net portion 204. Also as shown in FIG. 2, the mesh can be a chain link fence.

In an alternative embodiment, the wire mesh can employ a multi-layer wire structure in which the wire has an inner layer of a first material and an outer layer of a second material. Such an arrangement is shown in FIG. 4, in which wire 500 is formed having an inner portion such as core 554, having a first diameter 550, with an outer layer, such as cladding 556, of a second material and of thickness 552, formed thereon. In such an embodiment, the cladding thickness 552 is preferably greater in the upper net portion 202, preferably decreasing in lower net portion to compensate for differences in corrosiveness levels at different depths. In an embodiment, the material of core 554 can be optimized, for example, to reduce the overall weight of the net or to increase the strength thereof. Other characteristics and combinations thereof can be selected for core 554. Cladding 556 can be optimized for antifouling properties, for example. In an embodiment, core 554 is made from a metal, but alternatively can be made of or can additionally include other suitable materials such as a polymeric material, including plastic, nylon or the like. In a further embodiment, cladding 556 is made from copper or an alloy containing copper, which can include copper with tin, zinc, or nickel, or a combination thereof. Preferably, the thickness 556 of cladding 556 is such that core 554 remains unexposed to the water in which the net is used during the lifespan thereof. The core 554 can be formed to have a thickness 550 such that the net retains its structural integrity when cladding 556 is substantially fully corroded.

Descending farther away from the surface of the water, the lower net portion 204 is provided, as shown in FIG. 2. The wire of the lower net portion 204 can have a diameter ranging from about 0.5 mm to about 8 mm, preferably about 1.5-5 mm, more preferably about 2-4 mm, and in a particular embodiment is about 3 mm. The mesh can be woven into an opening having the ranges as set forth above for the upper portion. It is noted that the upper and lower portions of FIG. 2 include any upper and/or lower portion 202,204 and are not limited to an uppermost and lowermost portion.

In an exemplary embodiment similar to FIG. 1, the lower net portion 104 can extend in height about 5-25 meters, preferably about 7-20 meters, more preferably 10-15 meters, and in a particular preferred embodiment the height is about 13 meters. The height of the lower net portion 104 is shown as reference numeral 134, and is the dimension that extends vertically from the point where the lower net portion 104 begins to where it ends. For instance, as shown in FIG. 1, lower net portion 104 extends from its boundary with the lowest mid portion 116, to the bottom of the cage 100. In accordance with other embodiments of the invention, the cage 100 can have multiple lower portions. Each additional lower portion can decrease in average or minimum material thickness as the net portions descend farther away from the surface 122 of the water 120. Further, the gauge of each lower portion can successively increase as the portions move farther away from the surface 122. Similarly, the diameter of each lower portion can successively decrease as the portions move farther away from the surface 122.

Between the upper 102 and lower portion 104 of the cage, the invention can include a mid net portion 106 associated with the upper 102 and lower net portions 104. The wire mesh of the mid net portion 106 can have an average material thickness and gauge that are the same as that of either the upper and lower net portions 102, 104, or different from that of the upper and lower net portions. In one embodiment the average material thickness of the mid net portion 106 is between the average material thickness of the upper and lower portions 102, 104. For instance, the average material thickness of the mid net portion 106 can be less than that of the upper net portion 102, but greater than that of the lower net portion 104. As shown in FIG. 1, the mid net portion 106 can have plurality of net portions 112, 114, 116. Each of the plurality of net portions 112, 114, 116 can have a different average material thickness. In a preferred embodiment, the lowest mid portion 116, has a smaller average thickness than the upper 112 and middle 114 mid portions.

In the embodiment shown in FIG. 2, there is a connector element 206 that attaches the upper 202 and lower 204 net portions. The connector element 206 can include a wire that is woven between the upper 202 and lower 204 net portions, for example, in a spiral configuration along the lateral width 230 of the upper 202 and lower 204 net portions. To facilitate the connection between upper 202 and lower 204 net portions, in particular when a spiral configuration for connector 206 is used, it is preferred that the distance between the uppermost peaks 240a of lower net portion 204 are spaced apart at a distance that is about equal to the distance between the lowermost peaks 240b of upper net portion 202. In one embodiment, the connector element 206 extends completely around the circumference of the cage 100. In another embodiment, the connector element 206 includes several discrete elements connecting parts of the adjacent net portions to sufficiently maintain a secure connection. A further alternative embodiment of connecting element 206 can have a spiral configuration such a shown in FIG. 2, but can be configured to alternately engage half of each of the uppermost peaks 240a and the lowermost peaks 240b. It is noted that connector element 206 can either directly connect an upper and lower net portion, or can connect upper and lower net portions indirectly, via other net portions disposed between. In a similar fashion, a connector can be used to join together horizontally adjacent net portions. In such an embodiment, the connector could be a spiral connector, such as that which is shown in FIG. 2, that is vertically oriented. Other connectors that are acceptable for connecting vertically adjacent net portion could be similarly used to connect such horizontally adjacent net portions.

In embodiments having multiple lower portions, a connector element 206 can also be provided between each of the lower net portions. Alternatively, a mid portion can be present between the successive, adjacent portions. In another embodiment, adjacent net portions can be interwoven or otherwise connected directly to each other, such as by interweaving wires of each net portion with one or more wires of the other net portion.

The material thickness and the gauge of the connector element 206 can be the same or different as that of either of the upper 202 and lower 204 net portions. Also, the material of the connector element 206 can be different than that of the net portions and can be a synthetic material such as plastic, nylon or the like.

Preferably, the upper and lower net portions 202, 204 are made of a metal. In a particularly preferred embodiment, the upper and lower net portions 202, 204 are made of copper alloy, which can include copper with tin, zinc, or nickel, or a combination thereof. The alloy can be brass or bronze, for instance. According to one embodiment of the present invention, the upper and lower net portions are formed of about 90% copper and about 10% nickel. In another embodiment, the composition of the wire is about 64% copper, about 35% zinc, about 0.6% tin, and about 0.3% nickel. One example of the wire material that can be used is available from Sambo Copper Alloy Co, Ltd, as the UR30 alloy. In other embodiments, materials such as aluminum, stainless steel, galvanized steel, and aluminized steel can also be used. In a preferred embodiment, the same material composition is used for the upper net portions 202 and any lower net portions 204 that are included, to minimize or eliminate the problem of galvanic corrosion. Other net portions and the connector element can be formed of the same composition as the upper and lower net portions 202, 204, or have differing compositions.

Some embodiments of the invention are graded from one portion to the next, while other portions are internally graded. Each portion can include a single wire, and preferably a plurality of wires interwoven together. In a particularly preferred embodiment, a net portion includes 5 wires. In other embodiments, the graded thickness is accomplished by providing a wire or wires that extends in a downward direction with a thickness that decreases or otherwise varies along its length. This can be achieved by using individual wires of graded thickness sequentially adjacent each other and woven together.

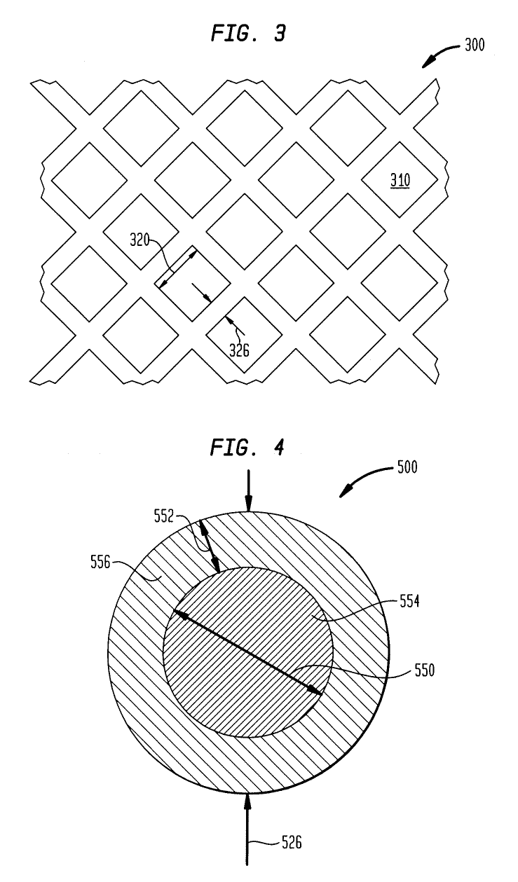

In alternate embodiments, one or more of the various net portions can be formed from a unitary metal structure having a plurality of openings formed therein to give the desired net structure. For example, the structure of FIG. 3 can be used in which net portion 300 includes a plurality of openings 310 having surrounded by metal segments having a thickness 326. The size of openings 310 and the segment thickness 326 are selected, as discussed above, to provide an adequate supply of fresh water to a net cage using the net structure and to correspond to the corrosiveness level of the net at a given depth of sea water. In one embodiment, net portion 300 is formed from expanded metal in which a number of slits are formed in a sheet of metal such that the metal can be stretched to form the desired net shape. Generally, the actual sizes of the features of the net formed from such a structure may vary due to deformation, including stretching, compressing, and twisting, of the material during formation of the net. Alternatively, a number of appropriately-sized openings can be formed by stamping or other known means in a sheet of metal. Different sheets can be used for different net portions, or a single sheet having gradations in the size of the openings can be used. For instance, the size of the openings can be smaller for the upper portion of the cage, and larger for the lower net portion of the cage. Preferably, the thickness decreases towards deeper parts of the wall. Additional alternative structures for a net for use in an embodiment of the net cage 100 shown in FIG. 1 including nets made from chain-mail having appropriately-sized openings. Further, a suitable net can be constructed from wires that are interwoven diagonally with each other or are in similar, alternative arrangements having suitably-sized openings.

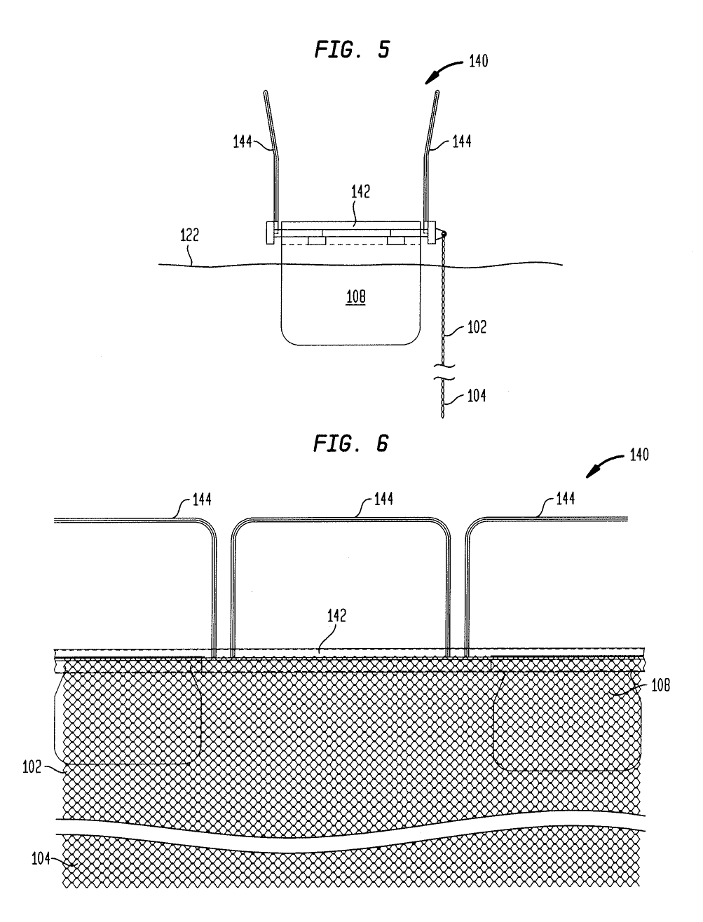

In the embodiment shown in FIG. 1 and, further shown in FIGS. 5 and 6, cage 100 has a buoyant support member 108 to support the upper portion 102 near water surface 122. The support member 108 is provided to maintain the cage at or above the surface 122 of the water body 120 and can be, for example, one or more floats, preferably along a perimeter of the cage 100. A top net 116 can be positioned over the top of the cage, for purposes such as keeping birds from accessing the fish in the cage 100. Additionally, cage 100 can have a walkway 140 around the perimeter thereof. Preferably, the walkway is made of a plurality of segments 142 that are affixed above the support member 108 that are preferably hinged together to compensate for any difference in water level from segment-to-segment. Further preferably, walkway segments 142 have rails 144 affixed thereto to promote safety when used. In a further embodiment, multiple cages 100 can be fastened together along the outer perimeters thereof to form a large cage assembly.

It has been found that corrosion is particularly pronounced and occurs at a higher rate in the top portion of aquatic cages, at and proximal to the surface of the water, and especially affects about the top meter in depth of the net. This is attributable to several factors, most prominent of which are the presence of highly aerated seawater in the surf zone, as well as higher current velocities and mechanical agitation that can act to remove any protective metal oxide film that can be formed on the metal surface. To address the problem of increased corrosion of aquaculture cages, particularly near the surface of the water, a corrosion-compensated net having a stratified or graded construction, in which the material thickness of the thereof varies inversely proportionally with water depth, or proportionally to the level of corrosive effects of the local environment about the various parts of the cage. The corrosion-compensated net is preferably provided in or as a wall, or the entire cage.

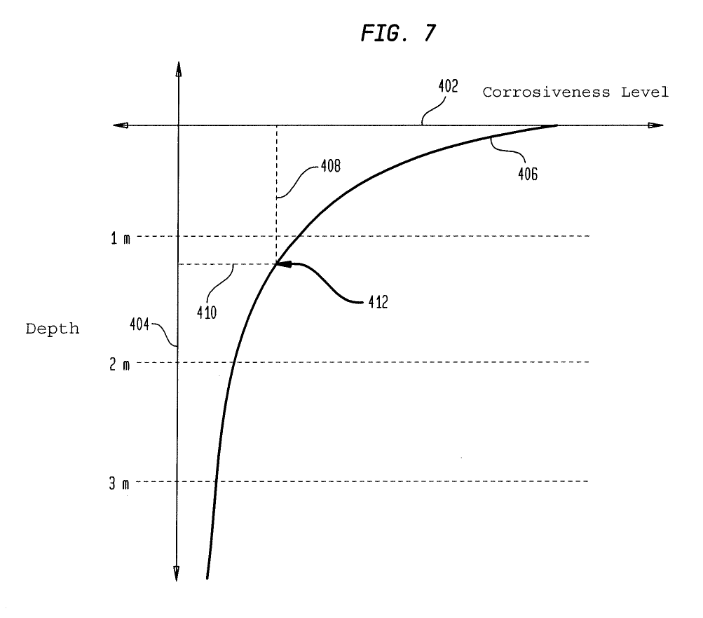

The graph shown in FIG. 7 illustrates an example of the rate of corrosion of a particular material at a given depth below the surface of a body of sea water. Axis 402 represents the corrosiveness level for the particular material in the body of sea water, and axis 404 represents the depth below the surface of the body of sea water. Accordingly, line 406 represents the particular corrosiveness level at a given depth, as influenced by the conditions of the environment. In the example shown in FIG. 7, the corrosion rate is greatest at depths less than 1 m. In this example, the depth 410 at which the upper net portion and lower net portion meet is selected such that a sufficiently low corrosiveness level 408, at which the lifespan of upper net portion and lower net portion, as limited by corrosion, is substantially equal. Depth 404 and corrosiveness level such 402 correspond to point 412 on line 406. Point 412 is shown as being located at a depth between 1 m and 2 m, although other depths can result from varying aquatic conditions, material characteristics and other such factors. A net optimized for even corrosion degradation throughout can have a material thickness that decreases with the depth below the water surface so as to approximately follow the reduction corrosiveness level.

In an alternative embodiment, such as where the local environments are more corrosive in regions other than at the top, a thicker material thickness is used in such other regions, which can be disposed remotely from the top. For instance, in an embodiment to be employed where the most corrosive environment exists towards in the middle of the cage, the cage can have the thickest material in that area to compensate for the increased rate of material consumption.

Copper alloys are preferred for their antifouling and antibacterial properties, which can create a healthier aquaculture environment within the cage. By using a suitable copper alloy instead of a synthetic material, the number of organisms that are able to attach and grow on the cage is significantly reduced, if not eliminated. For example, when compared to nylon nets, copper alloy nets have been found to exhibit only 5% blockage, compared to 75% for nylon nets.

Consequently, a major reduction in the number of pathogens and parasites can be achieved. Fewer pathogens or bacteria result in fewer infected fish, as well as an increase in the amount of oxygenated water that can reach the fish. This improved environment, created by the cage described herein, results in healthier fish and is able to sustain more fish. When compared to cages using a nylon net, copper alloy fish cages have shows a 50% increase in the number of fish per cage, and around 10-15% faster fish growth. Increased yields lead to greater profits and reduced operating cost per unit.

Metal nets, such as those including copper alloys, are further preferred over nylon in forming nets for aquaculture because metal nets produce less drag when submersed in a moving body of water. For example, nylon netting can produce 10% vibration when in body of water. Such vibration is an indication drag in water, which can cause a reduction in water flow through the net, and consequently the entire cage.

Using materials that naturally decrease pathogens decreases industry reliance on antibiotics. Reduced antibiotic use on fish in turn decreases the amount consumed by humans and the amount in the water and the greater marine ecosystem, and helps to slow the continual problem of increasing bacterial resistance. Additionally, research has shown that fish in copper alloy enclosures grow faster and require less food.

The graded corrosion-compensated net of the preferred embodiment, having different material thicknesses in upper and lower net sections, allows the various portions of the cage to reach maximum levels of corrosion more evenly, while reducing material and weight in the lower sections. The thicker upper portion is able to withstand the harsher environment of the surface, and lower net portion has a thinner thickness, selected to impart endurance of its comparatively milder corrosive environment farther beneath the surface of the water for a more equal amount of time than when the same material thickness us used. The present cage is more cost effective and lighter than metallic, corrosion-resistant cages known in the art, and can have a longer life, less corrosion, and minimal or no biofouling issues. In fact, by using the net described herein, the weight of the cage can be reduced by approximately 20-50% as compared to cages that use standard metallic nets. Although plastic and nylon nets often have an initial weight that is less than that of the graded metallic net discussed herein, plastic and nylon nets, as discussed above, are more susceptible to growth of pathogens and other marine life thereon. This additional growth, over time, can add significant additional weight to the net. For example, a typical plastic net can increase in weight by up to between 3 and 5 times its original weight during its lifespan due to growth of marine life thereon. Such additional weight can lead nylon or plastic nets to meet or exceed the weight of a graded metallic net. Furthermore, while nets made from plastic and nylon can be cleaned, they cannot be cleaned while in water because known cleaning processes use chemicals that are harmful to the aquatic environment. Accordingly, cleaning such nets can be a time-consuming and costly procedure, particularly when done during the lifetime of the fish held therein.

Embodiments of the invention allow for the option of preparing a net with a small mesh in order to utilize a single cage throughout the entire life cycle of the fish. For example, a small mesh, suitable for 100 gram salmon smolts can be prepared, the mesh and cage also being suitable to contain the fish until they reach their adult, harvest size of 3.5 kg. Due to the gradations in the thickness of the mesh, net, and cage as set forth in embodiments of the invention, such a cage with small mesh opening in the net can be produced without a prohibitive weight increase, thus eliminating floatation concerns.

Further, the antifouling properties of alloy nets, such as those including copper, obviate the need to replace nets frequently. It has been observed that copper alloy nets do not foul over the entire 18 month period of salmon growth from smolt to harvest. Avoiding the need to change nets reduces costs and simplifies the operation of farming operations. There is also a lesser amount of copper that is leached into the water, when compared to nylon nets that are coated with copper-based paint, resulting in a healthier marine environment.

A corrosion-compensated net with greater material thickness as described herein can allow for a reduction in the material used for a net designed to last a specific amount of time in a corrosive environment, because it allows for less material to be used in less corrosive areas in which material consumption is decreased. It can also allow for increased net life where the same total amount of material is used, since additional material is employed where material consumption rates are higher. For instance, if a net is being manufactured for an 18-month period, the amount of material required for the net to last this lifetime is reduced. Alternatively, if a longer use life is desired, the same amount of material can be used in a corrosion-compensated cage, resulting in this longer life. Yet another option is a balance between these factors; for example, a halfway point can be achieved by reducing the amount of material by a certain amount, while still increasing the life by a certain amount. Considering these factors, a net permitting at least adequate oxygen circulation within the cage having a lifespan of between about 18 months and 4 years before corrosion damage to the net becomes problematic.

As used in this application, the term “about” should generally be understood to refer to both the corresponding number and a range of numbers. Moreover, all numerical ranges herein should be understood to include each whole integer within the range.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention can be modified or varied without departing from the invention, as will be appreciated by those skilled in the art in light of the above teachings. Accordingly, all expedient modifications readily attainable by one of ordinary skill in the art from the disclosure set forth herein, or by routine experimentation therefrom, are deemed to be within the spirit and scope of the invention as defined by the appended claims.

1. A corrosion-compensated net, comprising upper and lower net regions associated with each other to provide a wall, wherein each of the upper and lower net regions has an exterior portion of a corrodible material, and wherein the respective outer portions of the upper and lower net regions are differently configured to compensate for a difference between corrosiveness levels of the environments at the upper and lower portions.

2. The corrosion compensated net of claim 1, wherein the upper net portion is configured to withstand a higher corrosiveness level than that of the lower net portion when exposed to the respective environments for equal amounts of time.

3. The corrosion-compensated net of claim 1, wherein the outer portions of the upper and lower net regions have different thicknesses to compensate for the difference between corrosiveness levels.

4. The corrosion-compensated net of claim 3, wherein outer portion of the upper net region has a greater thickness than the outer portion of the lower net region to compensate for the difference between corrosiveness levels.

5. The corrosion-compensated net of claim 3, wherein the outer portions of the upper and lower net regions comprise wire meshes, and wherein the respective thicknesses of the outer portions comprise the diameter of the wires of the meshes.

6. The corrosion-compensated net of claim 1, wherein the outer portion of the upper net region has a minimum thickness that is greater than a minimum thickness of the outer portion of the lower net region to compensate for the difference between corrosiveness levels.

7. The corrosion-compensated net of claim 6, wherein the outer portions of the upper and lower net regions comprise wire meshes, and the diameter of the wires of the upper region mesh is greater than the diameter of the wires of the lower region mesh to compensate for the difference between corrosiveness levels.

8. The corrosion-compensated net of claim 6, wherein the outer portion of at least one of the upper and lower net regions comprises a single material.

9. The corrosion-compensated net of claim 6, wherein at least one of the upper and lower net portions comprise an inner portion disposed within the outer portion.

10. The corrosion-compensated net of claim 6, further comprising a mid net region disposed between the upper and lower net regions.

11. The corrosion-compensated net of claim 10, wherein the thickness of the outer portion of the mid net region mid net region is between the thicknesses of the outer portions of the upper and lower net portions.

12. The corrosion-compensated net of claim 11, wherein the mid net region comprises a plurality of net regions each having an outer portion of a different thickness.

13. The corrosion-compensated net of claim 12, wherein the outer portions of the plurality of net regions have thicknesses decreasing from the upper net region to the lower net region, such that the cage has a graded thickness decreasing with increasing depth.

14. The corrosion-compensated net of claim 1, wherein the outer portions are made of a material that is corrodible by salt water.

15. The corrosion-compensated net of claim 14, wherein the outer portions are made of a metal.

16. The corrosion-compensated net of claim 15, wherein the metal comprises a copper alloy.

17. The corrosion-compensated net of claim 16, wherein the alloy includes at least one of nickel, tin, and zinc.

18. An aquaculture cage configured to contain marine life for aquaculture, the cage comprising the net of claim 1.
